(19) United States
(12) Patent Application Publication
(10) Pub. No.: US 2007/0027617 A1
(43) Pub. Date: Feb. 1, 2007

(54) RADIO NAVIGATION SYSTEM

(75) Inventors: Li Jian Li, Taipei (TW); Dian Gu, Taipei (TW); David Ho, Taipei (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Inventec Appliances Corporation

(21) Appl. No.: 11/459,967

(22) Filed: Jul. 26, 2006

(30) Foreign Application Priority Data
Jul. 29, 2005 (TW) 094125933

(51) Int. Cl. G01C 21/00

(52) U.S. Cl. 701/207; 340/988; 342/357.12

(57) ABSTRACT

A radio navigation system for use with an automobile audio device is provided. The radio navigation system includes a positioning receiver having a modulation transmitter and receiving a positioning signal, wherein the modulation transmitter converts the positioning signal into a modulated signal and then transmits the modulated signal; a demodulation receiver mounted in the automobile audio device, receiving the modulated signal and converting the modulated signal into a voice signal to the automobile audio device; and an output device outputting the voice signal and the positioning signal.

### FIELD OF THE INVENTION

The present invention relates to a radio navigation system, wherein a modulation signal is sent from the radio navigation system to a car audio, and the modulation signal is converted into a voice signal via the car audio.

### BACKGROUND OF THE INVENTION

FIG. 1 is a schematic diagram for a conventional positioning signal transmission, wherein the satellite emitter 11 in space transmits positioning signals 111 globally. If the moving automobiles 12 or 13 are equipped with a radio navigation system inside, the positioning information for the automobiles 12 or 13 is obtainable by receiving positioning signals 111 through the positioning receiver of the radio navigation system.

Please refer to FIGS. 2 and 3. FIG. 2 is a schematic diagram for a conventional radio navigation system, and FIG. 3 is a block diagram for a conventional radio navigation system. The automobile equipped with a radio navigation system 14 can receive the positioning signal 111, wherein the radio navigation system 14 comprises a positioning receiver and an output device. The output device comprises a liquid crystal screen and a loudspeaker. A large amount of electronic map information is stored in the radio navigation system 14. The precise position of the automobile can be obtained through the comparison between the positioning signal 111 and the coordinates in the electronic map information.

Please refer to FIG. 3, which is a block diagram for a conventional radio navigation system. As shown in FIG. 3, the radio navigation system 14 comprises a positioning receiver 141 and an output device 142. The positioning receiver 141 receives the positioning signal 111 and then transmits the positioning signal 111 to the output device 142.

The radio navigation system is a high-tech system, which provides the functions of driving guidance, route suggestion and information referencing. The automobile driver can obtain the required information by viewing the screen and listening to audio suggestions. The current radio navigation system is easy to be installed and the price therefore is inexpensive, but it still has disadvantages, e.g. the loudspeaker power and the audio signal quality are low. Therefore, when there is noise during driving, the road is bumpy, or the driver is not concentrated, the output voice signal would be covered up by the environmental noise so that the driver cannot clearly hear the voice signal.

From the above descriptions, it is known that if the loudspeaker power and audio signal quality of the radio navigation system are improved, the availability of the radio navigation system can be elevated. Therefore, the applicant proposes to add a set of FM emitter in the radio navigation system and use the radio inside the car audio as an FM receiver. Thus, the better-powered loudspeaker possessed by the car audio could provide a better expression method for the voice suggestion of the radio navigation system.

### SUMMARY OF THE INVENTION

In light of the above-mentioned shortcomings, the main purpose of the present invention is to provide a radio navigation system and apparatus on a car audio, wherein the radio navigation system comprises a positioning receiver, a demodulation receiver and an output device. The positioning receiver is used for receiving positioning signals transmitted by the satellite emitter. A modulation emitter is installed inside the positioning receiver to modulate the positioning signals and then transmit a modulated signal. In general, a demodulation receiver is installed inside the car audio as the receiving terminal for the modulated signal, and then the modulated signal is converted into the voice signal through the demodulation receiver. Finally, the voice signal is broadcasted by the output device of the car audio. Certainly, the output device is retained despite the improvement of the radio navigation system. The user can still observe the current driving condition via the liquid crystal screen of the output device and get the voice suggestion via the loudspeaker of the radio navigation system.

The voice suggestion can be output more efficiently through the car audio after simple improvement of the radio navigation system. This solves the problem that when encountering noise during driving, the voice signals outputted by the loudspeaker of the radio navigation system are covered up by the environmental noise.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram for a conventional positioning signal transmission;

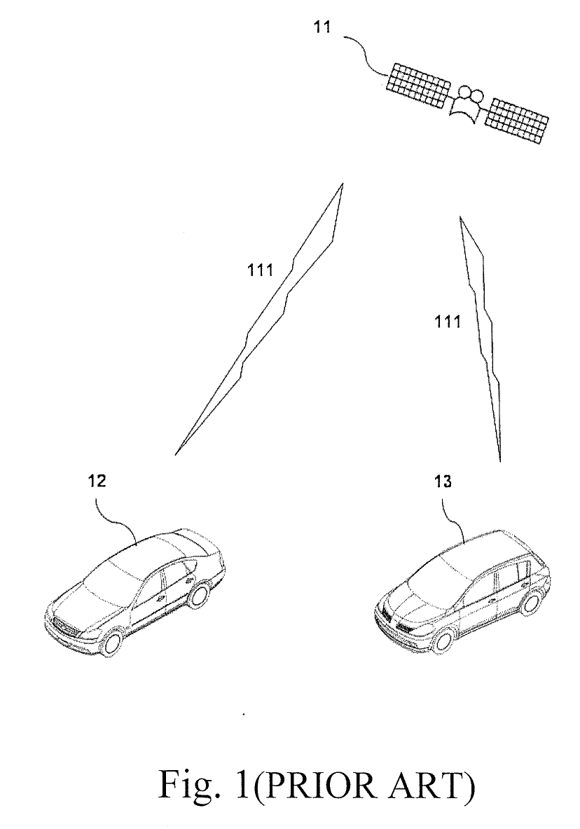

FIG. 2 is a schematic diagram for a conventional radio navigation system;

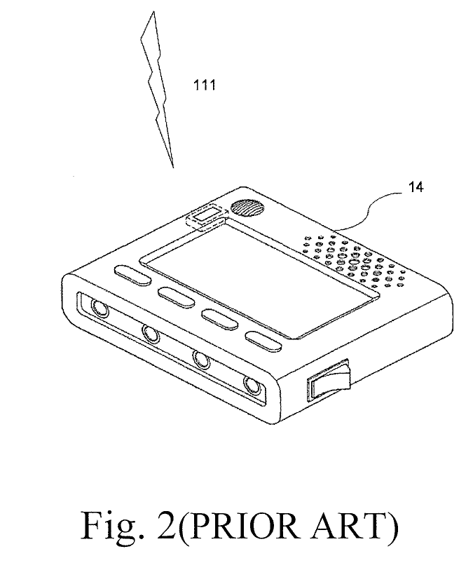

FIG. 3 is a block diagram for a conventional radio navigation system;

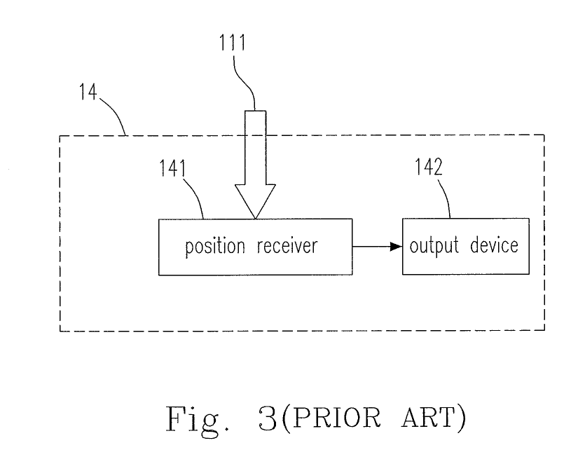

FIG. 4 is a flow chart showing how the radio navigation system transmits the voice signal according to the present invention;

FIG. 5 is a schematic diagram showing how the radio navigation system transmits the voice signal according to the present invention;

FIG. 6 is a block diagram for an radio navigation system according to the present invention; and

FIG. 7 shows an improved circuit configuration of a radio navigation system according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

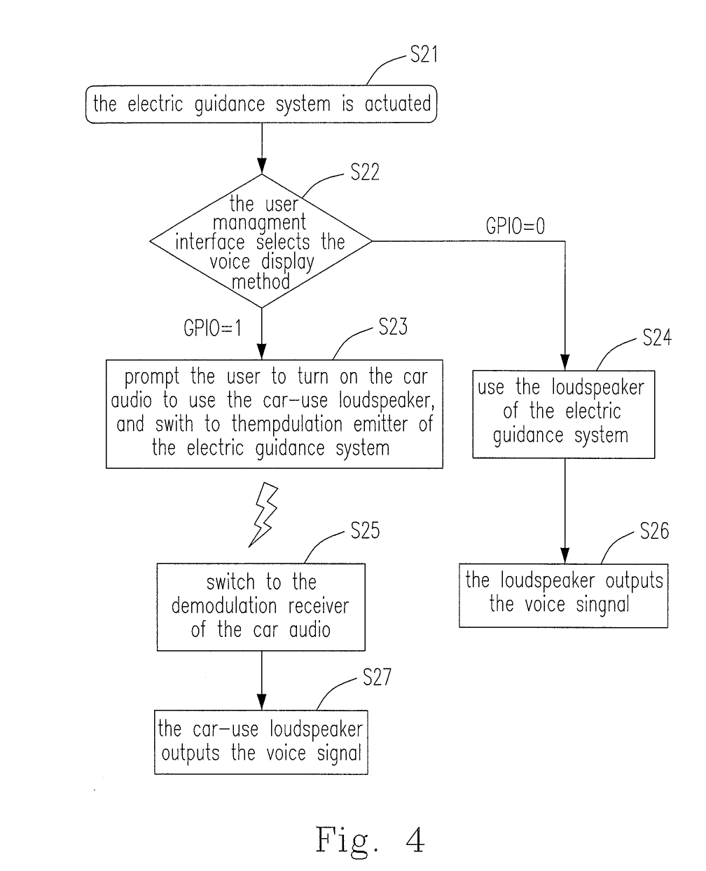

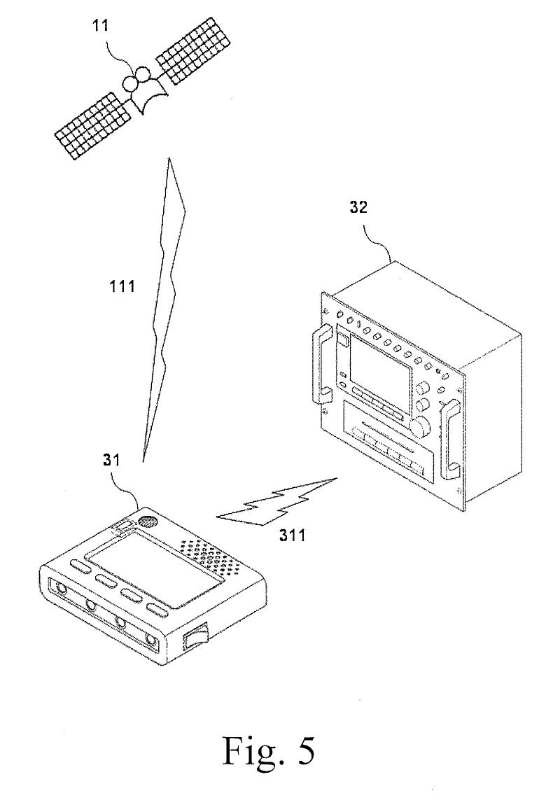

Please refer to FIGS. 4 and 5. FIG. 4 is a flow chart showing how the radio navigation system transmits the voice signal according to the present invention, and FIG. 5 is a schematic diagram showing how the radio navigation system transmits the voice signal according to the present invention. As shown in FIGS. 4 and 5, the user management interface selects the voice display method (S22) after the radio navigation system is actuated (S21). If the dual-channel programmable general-purpose input/output interface is in the state of “0”, then the loudspeaker of the radio navigation system is used (S24) to output the voice signal (S26). If the dual-channel programmable general-purpose input/output interface is in the state of “1”, then the user is prompted to turn on the car audio to use the car-use loudspeaker, switches to the modulation emitter of the radio navigation system (S23) for transmitting the modulated signal in a wireless way, and switches to the demodulation receiver of the car audio (S25) to output the voice signal via the car-use loudspeaker (S27). Through the above process, the voice signal transmission via the radio navigation system is completed.

Please refer to FIG. 5, which is a schematic diagram showing how the radio navigation system transmits the voice signal according to the present invention. As shown in FIG. 5, the satellite emitter 11 in space transmits the positioning signal 111 to the earth. The car is equipped with a radio navigation system 31, which comprises a modulation emitter. The modulation emitter uses a frequency modulation system to modulate the positioning signal 111, and then emits a modulated signal 311. Moreover, the demodulation receiver of the car audio is used to receive the modulated signal 311, wherein the demodulation receiver of the car audio and the modulation emitter of the radio navigation system use the same frequency modulation system, and the demodulation receiver of the car audio provides a channel setting selection function. When the frequency band of the modulation emitter of the radio navigation system 31 is identical to that of the demodulation receiver of the car audio, the modulation emitter transmits the modulated signal 311 to the demodulation receiver. Preferably, the demodulation receiver is a car radio 32.

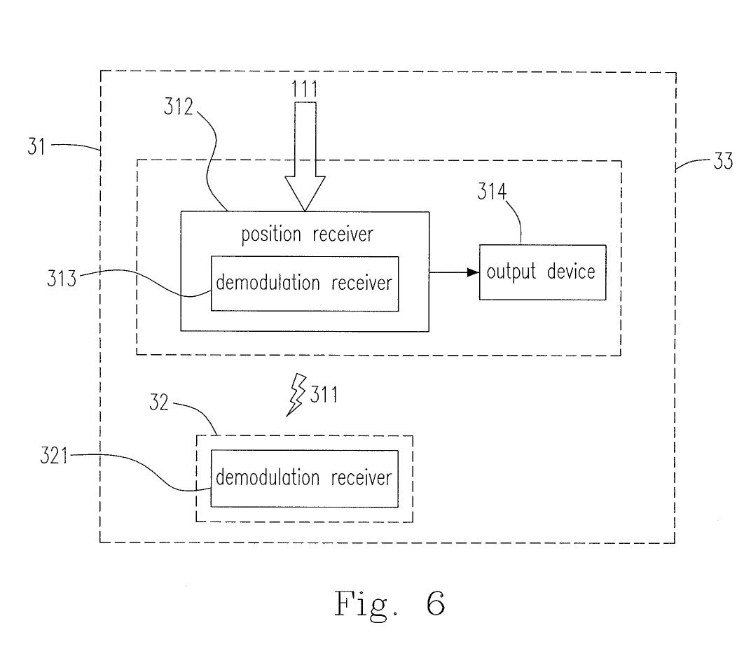

Please refer to FIG. 6, which is a block diagram for a radio navigation system according to the present invention. As shown in FIG. 6, the radio navigation system 31 comprises a positioning receiver 312 and an output device 314, wherein a demodulation receiver 313 is installed in the positioning receiver 312. The positioning receiver 312 receives the positioning signal 111, the demodulation receiver 313 converts the positioning signal 111 into the modulated signal 311, and then the demodulation receiver 313 emits the modulated signal 311. From the above descriptions, it is known that beside output through the output device 314 inside the radio navigation system 31, the positioning signal 111 also can receive the modulated signal 311 through the demodulation receiver 321 in the car radio 31, and then the car radio 32 outputs the modulated signal 311. Through the above descriptions, the signal transmission inside the radio navigation system 33 is illustrated.

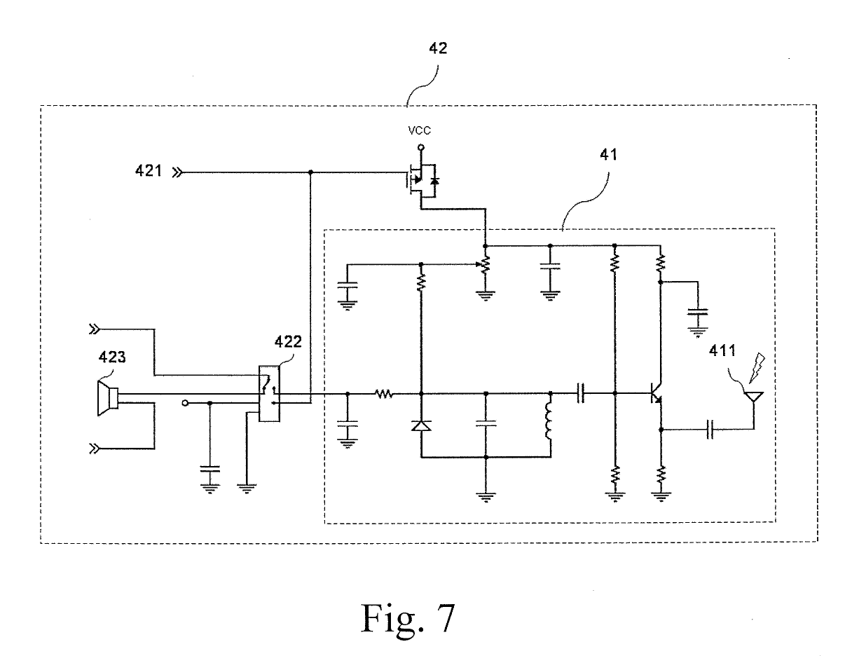

Please refer to FIG. 7, which shows an improved circuit configuration of a radio navigation system 42 according to the present invention. When the dual-channel programmable general-purpose input/output interface 421 is in the state of “0”, the relay 422 switches to the loudspeaker 423 of the radio navigation system, and thus the voice suggestion is output through the output device of the radio navigation system. When the dual-channel programmable general-purpose input/output interface 421 is in the state of “1”, the relay 422 switches to the FM modulation emitter 41 of the radio navigation system. The signal is modulated by the FM modulation emitter 41 and then sent out via the antenna 411.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A radio navigation system for use with an automobile audio device, comprising:
a positioning receiver receiving a positioning signal, said positioning receiver having a modulation transmitter for converting the positioning signal into a modulated signal for processing and radio transmission;
a demodulation receiver installed in the automobile audio device for converting the modulated signal received by radio into an audio signal which is transmitted to the automobile audio device; and
an output device for outputting the audio signal or the positioning signal.

2. The radio navigation system according to claim 1, wherein the automobile audio device comprises a loudspeaker as the output device.

3. The radio navigation system according to claim 2, wherein the automobile audio device provides a function of channel selection.

4. The radio navigation system according to claim 1, wherein the positioning receiver is a global positioning system (GPS) receiver.

5. The radio navigation system according to claim 1, wherein the modulation transmitter is a frequency modulation system.

6. The radio navigation system according to claim 1, wherein the demodulation receiver is a frequency modulation system.

7. The radio navigation system according to claim 1, wherein the positioning signal is capable of a relatively long distance transmission.

8. The radio navigation system according to claim 1, wherein the modulated signal is capable of a relatively short distance transmission.

9. The radio navigation system according to claim 1, wherein the output device is a loudspeaker.

10. The radio navigation system according to claim 1, wherein the output device is a liquid crystal display.

11. A radio navigation system, comprising:
a positioning receiver receiving a positioning signal, said positioning receiver having a modulation transmitter for converting the positioning signal into a modulated signal for processing and radio transmission; and
an output device for outputting the positioning signal.

12. The radio navigation system according to claim 11 used with an automobile audio device, the automobile audio device comprising a demodulation receiver for converting the modulated signal received by radio into an audio signal, and another output device for outputting the audio signal.

13. The radio navigation system according to claim 12 wherein the automobile audio device comprises an automobile loudspeaker as said another output device.

14. The radio navigation system according to claim 12, wherein the automobile audio device provides a function of channel selection.

15. The radio navigation system according to claim 11, wherein the positioning receiver is a global positioning system (GPS) receiver.

16. The radio navigation system according to claim 11, wherein the modulation transmitter is a frequency modulation system.

17. The radio navigation system according to claim 11, wherein the positioning signal is capable of a relative long-distance transmission.

18. The radio navigation system according to claim 11, wherein the modulated signal is capable of a relative short-distance transmission.

19. The radio navigation system according to claim 11, wherein the output device is a loudspeaker.

20. The radio navigation system according to claim 11, wherein the output device is a liquid crystal display.
